(19) United States
(12) Patent Application Publication
(10) Pub. No.: US 2004/0179052 A1
(43) Pub. Date: Sep. 16, 2004

(54) Imaging apparatus control using sensed sheet media characteristics

(76) Inventors: Quintin T. Phillips, Boise, ID (US); John Huffman, Meridian, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/388,858

(22) Filed: Mar. 14, 2003

(51) Int. Cl. B41J 13/00; B41J 2/01; G03G 15/00; B41J 3/407

(52) U.S. Cl. 347/14; 399/45; 399/381; 399/407; 347/101; 347/106

(57) ABSTRACT

Representative embodiments provide for a control system including a controller configured to selectively control an imaging apparatus, a sensor in signal communication with the controller and configured to provide a scan signal corresponding to sheet media, and a computer-accessible storage media in data communication with the controller and containing a data table, wherein the controller is configured to selectively gather data from the data table in response to the scan signal provided by the sensor. A method of the present invention includes receiving a print job from a user, providing a scan signal in response to sensing at least one sheet media characteristic, selectively reading sheet media data in response to the scan signal, and selectively controlling an imaging device of an imaging apparatus in response to the print job and the read sheet media data.

### BACKGROUND

Various kinds of imaging apparatus are known in the art. Non-limiting examples of such imaging apparatuses include laser printers, ink-jet printers, multi-function printers, photocopiers, and printers combined with sheet handling apparatus. Generally, an imaging apparatus is defined by any apparatus that can form images on sheet media, typically in response to an electronic document file (i.e., print job) provided to the imaging apparatus by a user computer or other suitable means coupled to the imaging apparatus.

Furthermore, some imaging apparatuses include additional sheet handling functionality, such as, for example, stapling, hole punching, collating, and/or sheet folding. Such sheet handling functions are typically provided by way of sheet handler that is supported by, and cooperatively coupled to, the imaging device (i.e., printer) of the imaging apparatus, such that a unitary imaging and sheet handling apparatus is defined. It is further known to use various different kinds of sheet media in conjunction with imaging apparatuses. Such sheet media include, for example, paper, transparencies, postcard stock, address labels, envelopes, etc. Other kinds of applicable sheet media are known.

Each of the different kinds of sheet media used with an imaging apparatus exhibits one or more characteristics relevant to the imaging and sheet handling functions described above. For example, a particular kind of paper can have a surface roughness that generally requires a certain amount of power to satisfactorily fuse toner to that particular paper while forming images with a laser printer. In another example, a certain postcard stock has a per-sheet thickness that generally determines the size of a staple required to satisfactorily bind a given stack-count (i.e., number of sheets arranged as a stack) of that certain postcard stock. Other examples of sheet media characteristics that affect imaging and/or handling operations are known.

Therefore, it is desirable to provide imaging apparatuses that operate in correspondence to the characteristics exhibited by the sheet media presently being imaged and possibly handled by a respective imaging apparatus.

### SUMMARY

One embodiment provides for a control system for use with an imaging apparatus, including a controller configured to selectively control the imaging apparatus in response to a print job provided by a user, and a sensor in signal communication with the controller and configured to provide a scan signal corresponding to a sensed characteristic of a sheet media. The control system further includes a computer-accessible storage media in data communication with the controller, and containing a data table. The controller is configured to selectively gather data from -the data table in response to the scan signal provided by the sensor.

Another embodiment provides for an imaging apparatus including a sensor configured to provide a scan signal corresponding to at least one sensed characteristic of a sheet media, and a computer-accessible storage media configured to store data, the computer accessible storage media storing sheet media data. The imaging apparatus also includes a controller in signal communication with the sensor and in data communication with the computer-accessible storage media. The controller is configured to selectively control the imaging apparatus in response to a print job provided by a user, and to selectively read the sheet media data in response to the scan signal. The imaging apparatus also includes an imaging device in control signal communication with the controller and configured to selectively form images on a sheet media, and a sheet handler in control signal communication with the controller and configured to selectively perform at least one operation on a sheet media.

Yet another embodiment provides for a method of operating an imaging apparatus, including receiving a print job from a user, sensing at least one sheet media characteristic, and providing a scan signal in response to the sensing at least one sheet media characteristic. The method further includes providing sheet media data, selectively reading the sheet media data in response to the scan signal, and selectively controlling an imaging device of the imaging apparatus in response to the print job and the read sheet media data.

Still another embodiment provides a method of operating an imaging apparatus, including receiving a teach command from a user, receiving sheet media data from a user, and storing the sheet media data in response to the teach command.

These and other aspects and embodiments will now be described in detail with reference to the accompanying drawings, wherein:

### DESCRIPTION OF THE DRAWINGS

FIG. 1 is a perspective view depicting an exemplary imaging apparatus in accordance with the prior art.

FIG. 2 is a block diagram depicting an imaging apparatus in accordance with an embodiment of the present invention.

FIG. 3 is a block diagram depicting a data table in accordance with the embodiment of FIG. 2.

FIG. 4 is flowchart depicting a method in accordance with the present invention.

FIG. 5 is a flowchart depicting another method in accordance with the present invention.

### DETAILED DESCRIPTION

In representative embodiments, the present teachings provide methods and apparatus for imaging apparatuses that are controlled in accordance with sensed and stored characteristics of a sheet media presently being imaged and (optionally) handled by an imaging apparatus.

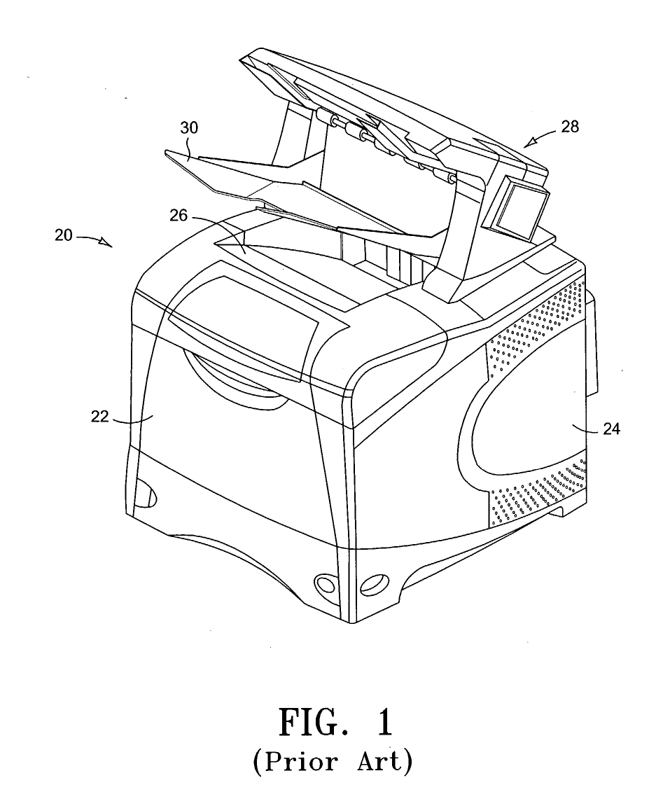

Turning now to FIG. 1, a perspective view depicts an exemplary imaging apparatus 20 in accordance with the prior art. The imaging apparatus 20 includes a printer 22. As shown, the printer 22 is assumed to be laser printer. Generally, any kind of printer 22 that can form images on sheet media (not shown) can be used. The printer 22 includes a housing 24. The housing 24 houses and supports a plurality of components (not shown) that are typically required for the various normal operations of the printer 22. One of skill in the imaging arts is familiar with such typical components of the printer 22, and further elaboration is not required for purposes herein. The printer 22 further includes an output tray 26. The output tray 26 generally receives imaged (i.e., printed) sheet media (not shown) from the printer 22.

The imaging apparatus 20 further includes a sheet handler 28. The sheet handler 28 is supported by, and disposed generally over, the printer 22 of the imaging apparatus 20. The sheet handler 28 is coupled in mechanical, electrical, and/or control signal communication with the printer 22 as required to selectively perform one or more typical sheet handling operations on printed sheet media (not shown) received from the printer 22. Non-limiting examples of sheet handling operations can include stapling sheet media, punching holes in sheet media, folding sheet media, collating sheets of media, etc. In general, any one, selected combination, or all of these, exemplary sheet handling operations can be incorporated as selectively available functions in the sheet handler 28. The sheet handler 28 includes a handler output tray 30, which receives printed and handled sheet media (not shown) from the sheet handler 28.

Operation of the imaging apparatus 20 is typically as follows: A print job is received by the imaging apparatus 20 from a user computer (not shown). The print job includes an electronic document file corresponding to images to be formed on sheet media, and can include additional instructions describing one or more sheet handling operations to be performed on the printed media. The printer 22 forms images on sheet media (not shown) in accordance with the print job. If the print job does not call for any operations by the sheet handler 28, then the printed sheet media are directed to the output tray 26. In the event that the print job does call for one or more operations of the sheet handler 28, say, stapling the printed sheet media together as a single document, then the printed sheet media (not shown) are directed from the printer 22 to the sheet handler 28, and then onto the handler output tray 30 once the sheet handling operation or operations are completed.

In general, satisfactory performance of the imaging apparatus 20 is determined, to some extent, by the characteristics of the particular sheet media imaged and optionally handled by the imaging apparatus 20. It is desirable to automatically predict (i.e., estimate or determine) relevant characteristics of a particular sheet media prior to performing imaging and handling operations on that particular sheet media. Such imaging apparatus and methods, in accordance with the present invention, are described hereafter.

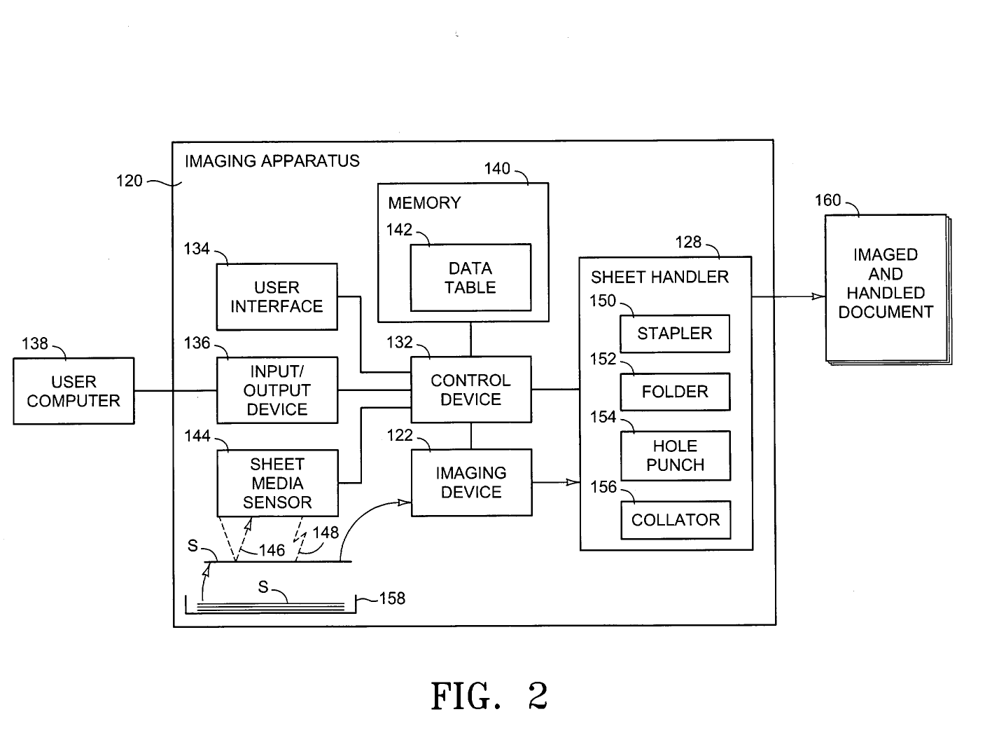

FIG. 2 is a block diagram depicting an imaging apparatus 120 in accordance with an embodiment of the present invention. The imaging apparatus 120 includes a control device (i.e., controller) 132. The controller 132 is coupled in control signal and/or data communication with other elements of the imaging apparatus 120 described hereafter. The controller 132 can include a microprocessor, a microcontroller, and/or other components, and is generally defined by any controller suitable for controlling various typical operations of the imaging apparatus 120. A number of such typical operations of the imaging apparatus 120 are described in detail hereafter.

The imaging apparatus 120 also includes an imaging device 122. The imaging device 122 is coupled in control signal communication with the controller 132. The imaging device 122 can be generally defined by a laser printing mechanism, an ink-jet mechanism, or any suitable mechanism that can selectively form images on sheet media S under the control of the controller 132.

The imaging apparatus 120 further includes a user interface 134. The user interface 134 is coupled in signal communication with the controller 132. The user interface 134 can include an electronic display, indicator lights, push buttons, and/or other elements (not shown). Generally, the user interface 134 can be defined by any suitable device that provides operational and/or status indications to a user and permits user selection and control of various operations of the imaging apparatus 120.

The imaging apparatus 120 also includes an input-output device (I/O device) 136. The I/O device 136 is coupled in signal communication with the controller 132, and generally facilitates the transfer of electronic data and control signals (such as, for example, a print job) between the controller 132 and a user device or devices external to the imaging apparatus 120. As shown, a user computer 138 exemplifies such an external user device coupled to the I/O device 136. The I/O device 136 is generally defined by any suitable electronics that can perform the transfer of data and control signals between the controller 132 and the user computer 138.

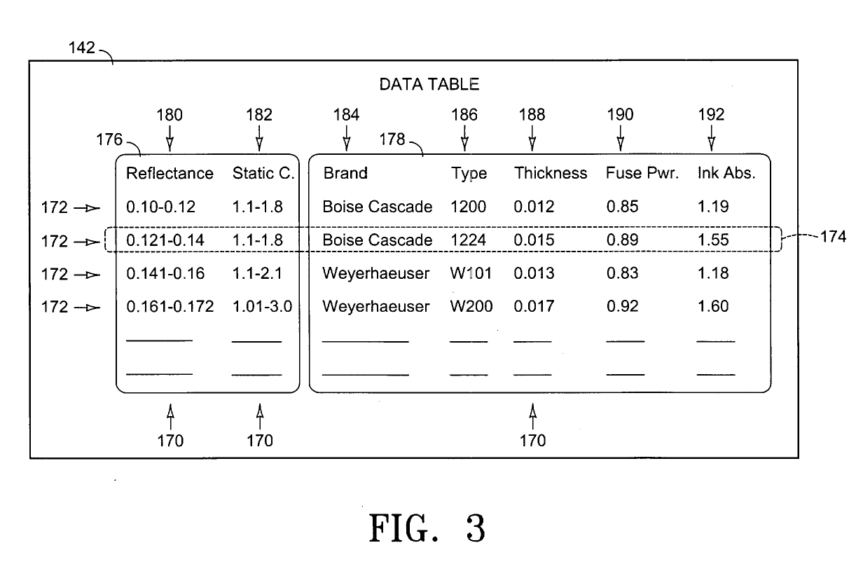

The imaging apparatus 120 further includes a computer-accessible storage media 140. The computer-accessible storage media 140 is coupled in data communication with the controller 132, and can be defined by any suitable storage media usable for selectively storing and retrieving (i.e., reading) data under the control of the controller 132. As shown, the computer-accessible storage media 140 is a solid-state memory (hereafter, memory). The memory 140 contains a data table 142. The data table 142 includes data corresponding to various characteristics of different kinds of sheet media S usable with the imaging apparatus 120. Further elaboration of the data table 142 is provided hereafter in regard to the description of FIG. 3.

The Imaging apparatus 120 also includes a sheet media sensor module 144. The sensor module 144 is coupled in signal communication with the controller 132. The sensor module 144 is configured to scan the sheet media S and to provide a scan signal to the controller 132 corresponding to one or more sensed characteristics of the sheet media S. The sensor module 144 can be defined by an optical sensor, an electrostatic charge sensor, an electrical resistance sensor, an ultrasonic sensor, or any cooperative combination of a number of these or other sensor types. Furthermore, the sensor module 144 can be defined by any number of such discrete sensor types that are respectively located, supported, and cooperatively configured as desired within the imaging apparatus 120.

Non-limiting examples of sensed characteristics of the media S can include surface roughness, color, electrostatic charge, electrical resistance, optical translucence, ultrasonic translucence, and surface reflectivity. Other characteristics of the sheet media S can also be sensed in accordance with the capabilities of the particular sensor module 144. One of skill in the related arts is aware of various sensing technologies that can be applied to sheet media S.

As shown in FIG. 2, the sensor module 144 senses (i.e., measures) the surface reflectance of the sheet media S using a reflected light beam 146. In addition, other properties of the media may be sensed such as an electrostatic charge 148 by way of respective sensing elements (not shown) incorporated into the sensor module 144, and provides a corresponding scan signal to the controller 132. Other embodiments (not shown) of the sensor module 144, having different sheet media S sensing abilities, can also be used. Further operative detail of the sensor module 144 is described hereafter.

The imaging apparatus 120 also includes a sheet handler 128. The sheet handler 128 is coupled in control signal communication with the controller 132. As shown, the sheet handler 128 includes a stapler 150, a sheet folder 152, a hole punch 154, and a collator 156. Other embodiments (not shown) of the sheet handler 128 can also be used. In general, the sheet handler 128 can be defined by any suitable one or more functional elements (i.e., stapler 150, etc.) that can be selectively applied to the sheet media S under the control of the controller 132.

The imaging apparatus 120 further includes an input tray 158. The input tray 158 supports a selective quantity of typically blank sheet media S for imaging and possible handling by the imaging apparatus 120. While only a single input tray 158 is shown in FIG. 2, it is to be understood that a plurality of substantially similar input trays 158, each supporting a respectively different kind of sheet media S, can be used with imaging apparatuses of the present invention. For example, an imaging apparatus (not shown) can include two such input trays 158, with one tray 158 supporting a stack of standard letter-size paper, and the other tray 158 supporting a stack of standard A4-size paper. Other embodiments of the imaging apparatus 120 can also be used.

Typical operation of the imaging apparatus 120 is generally performed as follows: The controller 132 of the imaging apparatus 120 receives a print job from the user computer 138 by way of the I/O device 136. The controller 132 then causes (typically) blank sheet media S to be drawn from the input tray 158, one sheet at a time, as required, by way of a suitable guiding and transport mechanism (not shown). The sensor module 144 then scans the sheet media S by way of the reflected light beam 146 and the sensed electrostatic charge 148, and sends a corresponding scan signal to the controller 132.

The controller 132 uses the scan signal from the sensor module 144 to query (i.e., selectively search and read) the data table 142 stored in the memory 140 so as to predict (i.e., determine) particular relevant characteristics of the sheet media S drawn from input tray 158. The controller 132 performs the query process by comparing the scan signal from the sensor module 144 with a plurality of sensed characteristic coefficients (not shown; see FIG. 3) stored in the data table 142. Once the controller 132 finds a suitable correlation (i.e., match that is within some predetermined tolerance) between the scan signal and one or more sensed characteristic coefficients, the controller 132 then reads the sheet media data within the data table 142 that is associated with the corresponding coefficient or coefficients. This read data includes various characteristics of the sheet media S that the controller 132 then selectively uses while processing the print job.

The sheet media S is then routed from the sensor module 144 to the imaging device 122. The controller 132 then causes the imaging device 122 to form images on the individual sheets of media S in accordance with the print job received from the user computer 138 and the data read from the data table 142. For purposes of example, it is assumed that the read data includes the amount of optical (i.e., laser or LED) power generally required to satisfactorily fuse toner to the particular sheet media S. The controller 132 then uses this power data to control the imaging device 122 accordingly while forming images on the sheet media S. Other examples of using the read data in conjunction with controlling the imaging device 122 are possible.

The image-bearing sheet media (not shown) is then transported from the imaging device 122 to the sheet handler 128. The controller 132 then causes the sheet handler 128 to perform one or more sheet handling operations on the image-bearing sheet media as individual sheets, as a number of groups, or gathered as a single bundle, in accordance with the print job. As shown in FIG. 2, the exemplary print job calls for stapling (binding) the image-bearing sheet media using the stapler 150 of the sheet handler 128. For further purposes of example, it is assumed that the read data includes the per-sheet thickness of the sheet media S. The controller 132 then uses this thickness data to determine what size staple (not shown) to use with the stapler 150, so as to bind the image-bearing sheet media into a single document 160. Upon binding of the document 160, the print job received by the imaging apparatus 120 is complete.

In another example (not shown), the imaging apparatus 120 forms images on several sheets of media S using the imaging device 122, which are then gathered and stapled by the stapler 150 and punched by the hole punch 143, for storage in a standard three-ring binder. Other typical operations of the imaging apparatus 120 can be performed.

In any case, the imaging apparatus 120 is generally configured to draw sheet media S from the input tray 158, scan the sheet media S using the sensor module 144, and compare the resulting scan signal with sensed characteristic coefficients stored in the data table 142 using the controller 132. Once the controller 132 finds a suitable correlation between the scan signal and some particular sensed characteristic coefficient or coefficients, the controller 132 then reads associated sheet media data from the data table 142. The controller 132 then uses the read data to control the imaging device 122 and the sheet handler 128 during the processing of a print job received from the user computer 138. Other embodiment (not shown) of imaging apparatus within the scope of the present invention can also be used.

Simultaneous reference is now made to FIGS. 2 and 3. FIG. 3 is a block diagram depicting detail of the data table 142 of FIG. 2. The data table 142 is generally defined by respective pluralities of data columns 170 and data rows 172. Each of the data rows 172 defines a single data record, exemplified as data record 174. Each data record (e.g., 174) represents characteristics associated with a particular kind of sheet media usable with the imaging apparatus 120. Thus, as shown, the data table 142 includes a total of six rows (records) 172, representing data for a corresponding six different kinds of sheet media.

Each of the columns 170 of the data table 142 represents a respective type of sheet media data. Furthermore, the data types of the columns 170 can be generally divided into two different classifications: sensed characteristic coefficients (hereafter, coefficients) 176; and sheet media characteristics (hereafter, characteristics) 178. The coefficients 176 are those data values (or ranges of values) that are compared, one record 172 at a time, to the scan signal provided by the sensor module 144, as the controller 132 seeks to find a suitable correlation. As shown, the data table 142 includes two types (columns 170) of coefficients 176, referred to as Reflectance 180 and Static Charge 182, respectively.

The characteristics 178 are those data values that represent potentially relevant physical characteristics of the six different kinds of sheet media represented within the data table 142. As shown, the data table 142 includes five types (columns 170) of characteristics 178, respectively represented as Brand Name 184, Type 186, Per-Sheet Thickness 188, Fusing Power Coefficient 190, and Ink Absorption Coefficient 192. During comparison by the controller 132, each Reflectance 180 type of coefficient 176 is compared to the corresponding scan signal content that represents the reflected light beam 146 of the sensor module 144. Also, each Static Charge 182 type of coefficient 176 is compared to the scan signal content that represents the electrostatic charge 148 sensed by the sensor module 144. Once the controller 132 finds a suitable match (i.e., correlation) within a record 172, it reads the associated characteristics 178 data within that record 172 and selectively uses that read data while processing a print job as described above.

The data table 142 of FIG. 3 is consistent with that of the imaging apparatus 120 of FIG. 2. It is to be understood that other embodiments of the present invention can use data tables (not shown) that are similar to data table 142, and that include any suitable number of data rows (records) and data columns (data types). Furthermore, other data tables (not shown) can include sheet media characteristic data and sensed characteristic coefficient data that corresponds to the particular sheet media resources and sensor abilities of the respective imaging apparatus (not shown) that utilizes a particular such data table.

In general, the present invention anticipates any data table stored in a computer-accessible storage media, which includes data selectively readable by a controller in response to scan signal content corresponding to sheet media, and wherein the read data is usable by the controller to selectively control typical operations of an imaging apparatus.

As shown in FIG. 3, the data table 142 includes records 172 for a total of six different kinds of sheet media S. However, a user of the imaging apparatus 120 can desire to make use of a different (i.e., new) kind of sheet media (not shown) that is not presently represented by the data table 142. It is therefore desirable to provide and store coefficients 176 and characteristics 178 of the data types 170 that correspond to the new sheet media within the data table 142 for use by the controller 132 of the imaging apparatus 120.

This is typically accomplished by initiating a “learn” mode of the imaging apparatus 120 in response to a “teach” command provided through the user computer 138 or the user interface 134. Thereafter, the imaging apparatus 120 is provided with the Brand Name 184, Type 186, Per-Sheet Thickness 188, Fusing Power Coefficient 190, and Ink Absorption Coefficient 192 (i.e., the characteristics 178) of the new sheet media by way of the user computer 138. Optionally, these characteristics 178 can be input to the imaging apparatus 120 via the user interface 134. For purposes of example, it is assumed that these data characteristics 178 are provided by the manufacturer of the new sheet media by way of an associated package label, via the Internet, by way of a telephone customer support line, etc.

Additionally, the Reflectance 180 and the Static Charge 182 (i.e., the coefficients 176) of the new sheet media are provided to the imaging apparatus 120 by scanning a sheet of the new sheet media using the sensor module 144. In the alternative, some predetermined plurality of new media sheets are successively scanned by the sensor module 144, for purposes of determining a statistical average or range for the corresponding scan signal content.

In any case, the controller 132 generally derives the coefficients 176 (as discrete values or ranges of values) for the new sheet media from the scan signal content, and stores these coefficients 176, along with the characteristics 178, of the new sheet media within the data table 142 of the memory 140. Once this data storage is complete, the “learn” mode is typically ended and the imaging apparatus 120 returns to other normal operation. Other embodiments and new data storage procedures are within the scope of the present invention.

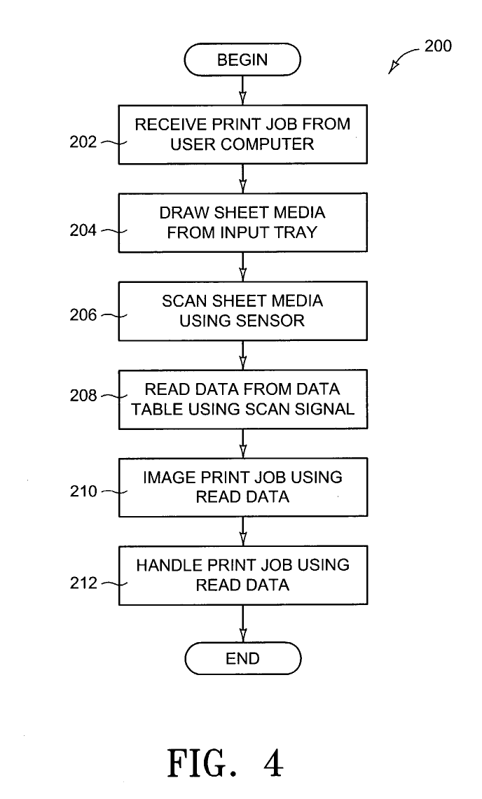

FIG. 4 is flowchart depicting a method 200 for operating the present invention. The method 200 is described within the context of the imaging apparatus 120 of FIG. 2 in the interest of clarity, but it is to be understood that the method 200 is substantially applicable to the operation of any embodiment of the present invention.

In step 202, the imaging apparatus 120 receives a print job from the user computer 138. In particular, the print job is received by the controller 132 via the I/O device 136.

In step 204, the controller 132 causes a sheet media S to be drawn from the input tray 158 and routed toward the sensor module 144.

In step 206, the sensor module 144 scans the surface reflectance of the sheet media S using the reflected light beam 146, and senses the electrostatic charge 148 borne by the sheet media S. The sensor module 144 then provides a corresponding scan signal to the controller 132 in response to the sensing.

In step 208, the controller 132 successively compares the scan signal content with the coefficients 176 stored in the data table 142. Once the controller 132 finds a record 172 that is suitably correlated to the scan signal content, the controller 132 reads the characteristic 178 data content of the record 172.

In step 210, the controller 132 proceeds by causing the imaging device 122 to form images on one or more sheets of the media S in accordance with the print job. For purposes of example, it is assumed that the print job calls for several imaged and handled sheets of media, which are then routed to the sheet handler 128, and the controller 132 proceeds to step 212. In another case (not shown), in which sheet handling is not called for, the controller 132 causes the imaged sheet or sheets of media to be suitably discharged from the imaging apparatus 120, at which point the print job is complete.

In step 212, the controller 132 causes the sheet handler 128 to perform one or more operations on the imaged sheet media in accordance with the print job. For purposes of ongoing example, it is assumed that the print job calls for binding the sheet media as a single document 160 using the stapler 150 of the sheet handler 128. Once this operation is complete, the imaged and handled document 160 is suitably discharged from the imaging apparatus 120. The exemplary print job is now complete.

Other methods (not shown) for typically operating imaging apparatuses of the present invention can also be used.

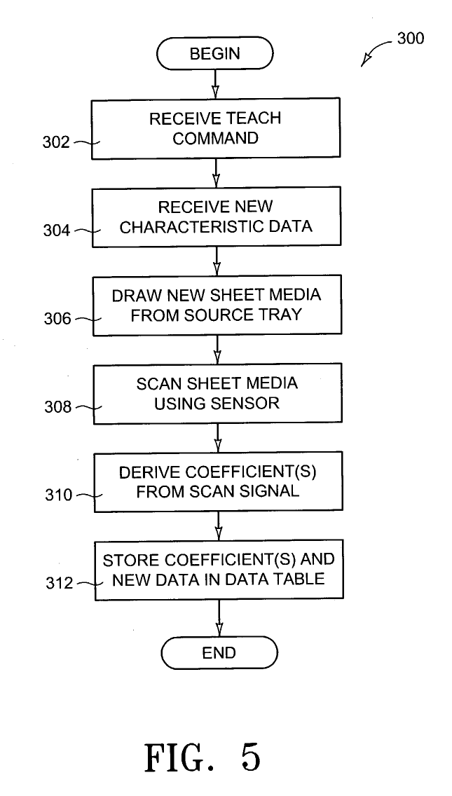

FIG. 5 is a flowchart depicting a method 300 for performing new data storage operation of the present invention. The method 300 is described in the context of the imaging apparatus 120 of FIG. 2, but it is to be understood that the method 300 is substantially applicable to the new data storage operation of any embodiment of the present invention.

In step 302, the imaging apparatus 120 receives a Teach command from a user, by way of the user computer 138. Optionally, the user interface 134 can be used to provide the Teach command. In any case, the controller 132 assumes a Learn mode of operation.

In step 304, the imaging apparatus 120 receives sheet media characteristics 178 associated with a new sheet media, by way of the user computer 138 (optionally, via the user interface 134).

In step 306, the controller 132 causes one or more sheets of the new media to be drawn from the input tray 158 and directed toward the sensor module 144.

In step 308, the sensor module 144 scans the sheet or sheets of new media and provides a corresponding scan signal to the controller 132 in response to each scanned sheet.

In step 308, the controller 132 uses the scan signal or signals to derive the coefficients 176 for the new sheet media.

In step 310, the controller 132 stores the coefficients 176 and the characteristics 178 in the data table 142 of the memory 140. The controller 132 now terminates the Learn mode and returns the imaging apparatus 120 to other normal operations.

Other methods (not shown) for performing new data storage can also be used.

Although the flow charts of FIGS. 4 and 5 show a specific order of execution, the order of execution may differ from that which is depicted. All such variations are within the scope of the present invention.

The present invention can be generally summarized as follows: An imaging apparatus receives a print job from a user computer or other suitable source coupled to the imaging apparatus. In response to the print job, a controller causes a sensor to scan sheet media and to provide a scan signal or signals corresponding to one or more sensed characteristics of that sheet media to the controller. The controller then uses the scan signals to selectively query (search) a data table for a record associated with the scanned sheet media. Once the controller finds a suitably corresponding record within the data table, characteristic data within that record is read and selectively used to control an imaging device and (optionally) a sheet handler, so as to produce imaged and (optionally) handled sheet media in accordance with the print job.

While the above methods and apparatus have been described in language more or less specific as to structural and methodical features, it is to be understood, however, that they are not limited to the specific features shown and described, since the means herein disclosed comprise preferred forms of putting the invention into effect. The methods and apparatus are, therefore, claimed in any of their forms or modifications within the proper scope of the appended claims appropriately interpreted in accordance with the doctrine of equivalents.

I claim:

1. A control system for use with an imaging apparatus, comprising:
a controller configured to selectively control the imaging apparatus in response to a print job provided by a user;
a sensor in signal communication with the controller and configured to provide a scan signal corresponding to a sensed characteristic of a sheet media; and
a computer-accessible storage media in data communication with the controller and containing a data table, wherein the controller is configured to selectively gather data from the data table in response to the scan signal provided by the sensor.

2. The control system of claim 1, and wherein the controller is further configured to selectively control an imaging device of the imaging apparatus in response to the data gathered from the data table.

3. The control system of claim 2, and wherein the controller is further configured such that the selective control of the imaging device is defined by at least one of controlling a power used to fuse a toner to a sheet media, controlling a quantity of an ink applied to a sheet media, or controlling a gap between the imaging device and a sheet media.

4. The control system of claim 1, and wherein the controller is further configured to selectively control an automated stapler of the imaging apparatus in response to the data gathered from the data table.

5. The control system of claim 4, and wherein the controller is further configured such that the selective control of the automated stapler is defined by at least one of controlling a power used to apply a staple to a sheet media, controlling a size of a staple applied to a sheet media, or controlling which one of a plurality of a stapling devices of the automated stapler to apply to a sheet media.

6. The control system of claim 1, and wherein the controller is further configured to selectively control a sheet handler of the imaging apparatus in response to the data gathered from the data table.

7. The control system of claim 6, and wherein the controller is further configured such that the selective control of the sheet handler is defined by at least one of controlling a stapler, controlling a sheet folder, controlling a collator, or controlling a hole punch.

8. The control system of claim 1, and wherein the sensor is defined by an optical sensor.

9. The control system of claim 1, and wherein the sensor is defined by an electrostatic sensor.

10. The control system of claim 1, and wherein the sensor is defined by an ultrasonic sensor.

11. The control system of claim 1, and wherein the sensor is defined by an electrical resistance sensor.

12. The control system of claim 1, and wherein the data table contained in the computer-accessible storage media includes data corresponding to at least one particular kind of sheet media, and wherein the data includes at least one of a sensed characteristic coefficient, a brand name, a type name, a roughness coefficient, a color, a thickness, an ink absorption coefficient, or a toner fusing-power coefficient.

13. The control system of claim 1, and wherein the controller is further configured to selectively store data in the data table of the computer-accessible storage media in response to a user input to the imaging apparatus.

14. The control system of claim 13, and wherein the controller is further configured such that the data selectively stored in the data table includes at least one of a sensed characteristic coefficient, a brand name, a type name, a roughness coefficient, a color, a thickness, an ink absorption coefficient, or a toner fusing-power coefficient.

15. The control system of claim 14, and wherein the controller is further configured to derive the sensed characteristic coefficient from the scan signal provided by the sensor prior to the storing the data in the data table.

16. The control system of claim 1, and wherein the controller is further configured to selectively change at least some of the data stored in the data table of the computer-accessible storage media in response to user input to the imaging apparatus.

17. The control system of claim 1, and wherein the controller is further configured to selectively delete at least some of the data stored in the data table of the computer-accessible storage media in response to a user input to the imaging apparatus.

18. An imaging apparatus, comprising:
a sensor configured to provide a scan signal corresponding to at least one sensed characteristic of a sheet media;
a computer-accessible storage media configured to store data, the computer-accessible storage media storing sheet media data;
a controller in signal communication with the sensor and in data communication with the computer-accessible storage media and configured to selectively control the imaging apparatus in response to a print job provided by a user, the controller further configured to selectively read the sheet media data in response to the scan signal;
an imaging device in control signal communication with the controller and configured to selectively form images on a sheet media; and
a sheet handler in control signal communication with the controller and configured to selectively perform at least one operation on a sheet media.

19. The imaging apparatus of claim 18, and wherein the controller is further configured to selectively control the imaging device in response to the selectively read sheet media data.

20. The imaging apparatus of claim 18, and wherein the controller is further configured to selectively control at least one of a power used by the imaging device to fuse a toner to a sheet media, a quantity of an ink applied to a sheet media by the imaging device, or a gap between the imaging device and a sheet media.

21. The imaging apparatus of claim 18, and wherein the controller is further configured to selectively control the sheet handler in response to the selectively read sheet media data.

22. The imaging apparatus of claim 18, and wherein the controller is further configured to selectively control at least one of a stapler of the sheet handler, a sheet folder of the sheet handler, a collator of the sheet handler, or a hole punch of the sheet handler.

23. The imaging apparatus of claim 18, and wherein the controller is further configured to selectively read the sheet media data in response to a comparison between the scan signal and at least one sensed characteristic coefficient stored in the computer-accessible storage media.

24. The imaging apparatus of claim 18, and wherein the controller is further configured to selectively store the sheet media data in the computer-accessible storage media in response to a user input to the imaging apparatus.

25. The imaging apparatus of claim 18, and wherein the sheet media data stored in the computer-accessible storage media includes at least one of a sensed characteristic coefficient, a brand name, a type name, a roughness coefficient, a color, a thickness, an ink absorption coefficient, or a toner fusing-power coefficient.

26. The imaging apparatus of claim 25, and wherein the controller is further configured to derive the sensed characteristic coefficient from the scan signal prior to the storage of the sheet media data in the computer-accessible storage media.

27. The imaging apparatus of claim 18, and wherein the sensor is defined by at least one of an optical sensor, an electrostatic sensor, an ultrasonic sensor, or an electrical resistance sensor.

28. The imaging apparatus of claim 18, and wherein the controller is further configured to selectively change at least some of the sheet media data stored in the computer-accessible storage media in response to a user input to the imaging apparatus.

29. The imaging apparatus of claim 18, and wherein the controller is further configured to selectively delete at least some of the sheet media data stored in the computer-accessible storage media in response to a user input to the imaging apparatus.

30. An imaging apparatus, comprising:
sensor means for providing a scan signal corresponding to a sensed sheet media characteristic;
storage means for storing sheet media data;
control means coupled in signal communication to the sensor means and the storage means and configured to selectively control the imaging apparatus in response to a print job provided by a user, the control means further configured to selectively read the sheet media data in response to the scan signal;
imaging means for selectively forming images on a sheet media, the imaging means coupled in signal communication with the control means; and
handler means for selectively performing at least one operation on a sheet media, the handler means coupled in signal communication with the control means, wherein the control means is further configured to selectively control the imaging means and the handler means in response to the read sheet media data.

31. The imaging apparatus of claim 30, and wherein the control means is further configured to selectively read the sheet media data in response to a comparison between the scan signal and a sensed characteristic coefficient stored in the storage means.

32. A method of operating an imaging apparatus, comprising:
receiving a print job from a user;
sensing at least one sheet media characteristic;
providing a scan signal in response to the sensing at least one sheet media characteristic;
providing sheet media data;
selectively reading the sheet media data in response to the scan signal; and
selectively controlling an imaging device of the imaging apparatus in response to the print job and the read sheet media data.

33. The method of claim 32, and further comprising selectively controlling a sheet handler of the imaging apparatus in response to the print job and the read sheet media data.

34. The method of claim 32, and wherein the selectively reading the sheet media data is performed in response to comparing the scan signal with a sensed characteristic coefficient that is part of the sheet media data

35. A method of operating an imaging apparatus, comprising:
receiving a teach command from a user;
receiving sheet media data from a user;
storing the sheet media data in response to the teach command

36. The method of claim 35 and further comprising sensing a sheet media characteristic in response to the teach command, deriving a sensed characteristic coefficient in response to the sensing, and storing the sheet media data and the sensed characteristic coefficient.
